(19) United States
(12) Patent Application Publication
(10) Pub. No.: US 2006/0167991 A1
(43) Pub. Date: Jul. 27, 2006

(54) Buddy list filtering

(76) Inventors: Brian D. Heikes, Ashburn, VA (US); David Gang, Oakton, VA (US)

Correspondence Address: FISH & RICHARDSON P.C., P.O. BOX 1022, MINNEAPOLIS, MN, 55440-1022, US

(21) Appl. No.: 11/013,312

(22) Filed: Dec. 16, 2004

(51) Int. Cl. G06F 15/16

(52) U.S. Cl. 709/204

(57) ABSTRACT

Customizing instant messaging communications for a first instant messaging participant includes receiving first filter criteria corresponding to an online presence state of instant messaging participants to be filtered. First information associated with each of one or more other instant messaging participants selected by the first instant messaging participant is accessed. The first filter criteria is applied to the first information for each of the other instant messaging participants to obtain a first filter result for each of the other instant messaging participants. A participant list is configured to persistently reflect a display of information about the other instant messaging participants according to the first filter result for each of the other instant messaging participants.

### TECHNICAL FIELD

The following description relates generally to configuring a user interface, such as an instant messaging user interface.

### BACKGROUND

Online service providers offer new services and upgrade existing services to enhance a user's online experience. Users have on-demand access to news, weather, financial, sports, and entertainment services, and have the ability to transmit electronic messages and to participate in online discussion groups. For example, users of online service providers such as America Online may view and retrieve proprietary or third party content on a wide variety of topics from servers located throughout the world.

One such service is instant messaging. Members of an instant messaging service can communicate virtually in real time with other instant messaging members. Members may manually create a list of screen names for other members, and may establish instant messaging sessions with those other members using a list of screen names, which also may be referred to as a buddy list.

### SUMMARY

Buddy list members may be displayed on a buddy list according to filter criteria, and a user may be given the ability to change the filter criteria. Filtering may be transient or permanent, and the criteria may differ depending upon whether the filtering is transient or permanent. For example, a permanent filter may allow filtering with more criteria or different criteria than a transient filter. Filtering may be performed, for example, on a group-by-group basis for different groups on the user's buddy list. Filtering also may be performed, for example, based on status, such as idle, away, or mobile status. Filtering also may be performed on a priority basis that is pre-designated, automatically designated, or user-assigned. For example, the system or a user may assign a priority of high, medium, or low to one or more of the buddies on the user's buddy list. Thereafter, the high priority buddies, the medium priority buddies, and the low priority buddies are displayed differently in the user's buddy list.

Default filter criteria may sort by group and status, such as idle, away or mobile status, such that idle, away, and mobile buddies are not shown. Sorting also may be performed using alphabetical criteria. The buddy list may include an indicator that shows which filter is currently being applied, and whether the filter is transient or permanent in nature. In one implementation, the user is given the ability to disable the filtering display on the buddy list. The user also may be able to set a no-filtering condition in the buddy list such that no filtering is performed for designated groups, buddies or buddy characteristics.

In a general aspect, a method of customizing instant messaging communications for a first instant messaging participant includes receiving first filter criteria corresponding to an online presence state of instant messaging participants to be filtered. First information associated with each of one or more other instant messaging participants selected by the first instant messaging participant is accessed. The first filter criteria is applied to the first information for each of the other instant messaging participants to obtain a first filter result for each of the other instant messaging participants. A participant list is configured to persistently reflect a display of information about the other instant messaging participants according to the first filter result for each of the other instant messaging participants.

Implementations may include one or more of the following. For example, configuring the participant list may include one or more of: (i) including or excluding each of the other instant messaging participants in the display of the participant list based on the first filter result for each of the other instant messaging participants; (ii) sorting the other instant messaging participants in the display of the participant list based on the first filter result for each of the other instant messaging participants; and/or (iii) grouping the other instant messaging participants in the display of the participant list based on the first filter result for each of the other instant messaging participants.

The first information may include an online presence state information each of the other instant messaging participants. The first filter result may include an online presence state for each of the other instant messaging participants. Applying the filter criteria may include applying the filter criteria at a client system at which the participant list is displayed or applying the filter criteria at a host system that communicates with the client system.

The method may further include receiving second filter criteria, accessing second information associated with each of one or more other instant messaging participants, and applying the second filter criteria to the second information for each of the other instant messaging participants to obtain a second filter result for each of the other instant messaging participants. Configuring the participant list may include configuring the participant list to persistently reflect a display of information about the other instant messaging participants according to the first and second filter results for each of the other instant messaging participants.

Configuring the participant list may include: (i) including or excluding each of the other instant messaging participants in the display of the participant list based on the first filter result for each of the other instant messaging participants and sorting the other the other instant messaging participants in the display of the participant list based on the second filter result for each of the other instant messaging participants; (ii) including or excluding each of the other instant messaging participants in the display of the participant list based on the first filter result for each of the other instant messaging participants and grouping the other the other instant messaging participants in the display of the participant list based on the second filter result for each of the other instant messaging participants; and/or (iii) sorting the other the other instant messaging participants in the display of the participant list based on the first filter result for each of the other instant messaging participants and grouping the other the other instant messaging participants in the display of the participant list based on the second filter result for each of the other instant messaging participants.

The second filter criteria may be based upon an alphabetical order of instant messaging participants and/or a priority associated with instant messaging participants. The priority may include a priority assigned by the first participant, an automatically assigned priority, and/or a default priority. The second information may include group assignment information and/or assigned priority information. The priority may include a priority assigned by the first participant and/or an automatically assigned priority. The second filter result may include an instant messaging group.

The method may further include displaying the filtered participant list to the first instant messaging user. Configuring the participant list may include configuring a displayed order of screen names of the one or more other instant messaging participants, changing the displayed order of the screen names, and/or configuring the participant list to display the other instant messaging participants according to a priority associated with each of the other instant messaging participant.

These general and specific aspects may be implemented using a system, a method, or a computer program, or any combination of systems, methods, and computer programs.

Other features will be apparent from the description and drawings, and from the claims.

### DESCRIPTION OF DRAWINGS

FIG. 1 is a block diagram of an exemplary communications system.

FIGS. 2-5 are expansions of the exemplary block diagram of FIG. 1.

FIG. 6 is a flow chart of an exemplary method that may be implemented by the systems of FIGS. 1-5.

FIGS. 7-14 are exemplary user interfaces that may be displayed by the systems of FIGS. 1-5.

### DETAILED DESCRIPTION

Using the described techniques, a user is able to filter an instant messaging buddy list to more easily identify “high value buddies” with whom the user wishes to communicate. The filtering may be based upon criteria such as a group of buddies in the buddy list, a status such as an away status, a mobile status, or an idle status, a pre-designated hierarchy, an automatically designated hierarchy, or a user-designated hierarchy. The filtering may be permanent or temporary. A temporary filter lasts for a single instant messaging communications session. A permanent filter lasts across multiple instant messaging communications sessions. Buddy list filtering techniques allow a user to more easily find buddy list members who have certain desired characteristics.

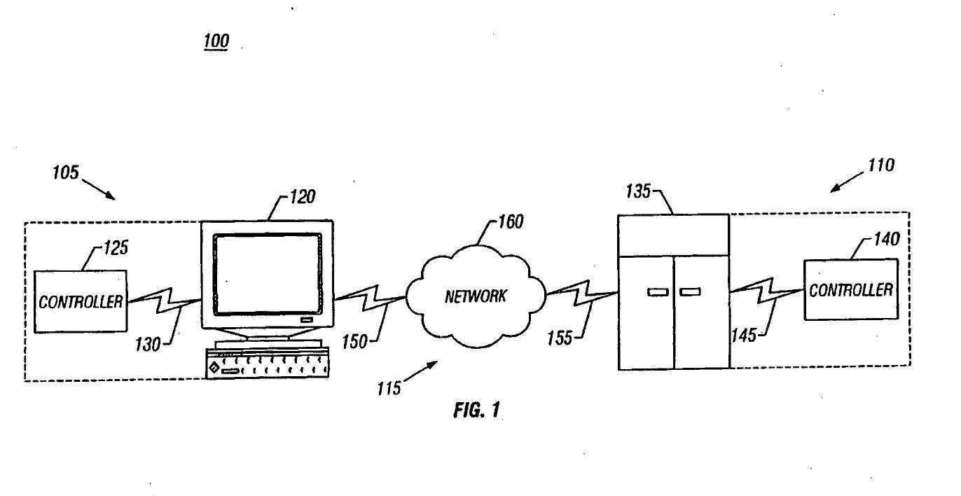

For illustrative purposes, FIGS. 1-5 show an exemplary communications system for implementing techniques for transferring electronic data. For brevity, several elements in the figures described below are represented as monolithic entities. However, as would be understood by one skilled in the art, these elements each may include numerous interconnected computers and components designed to perform a set of specified operations and/or may be dedicated to a particular geographical region.

Referring to FIG. 1, a communications system 100 is capable of delivering and exchanging data between a client system 105 and a host system 110 through a communications link 115. The client system 105 typically includes one or more client devices 120 and/or client controllers 125, and the host system 110 typically includes one or more host devices 135 and/or host controllers 140. For example, the client system 105 or the host system 110 may include one or more general-purpose computers (e.g., personal computers), one or more special-purpose computers (e.g., devices specifically programmed to communicate with each other and/or the client system 105 or the host system 110), or a combination of one or more general-purpose computers and one or more special-purpose computers. The client system 105 and the host system 110 may be arranged to operate within or in concert with one or more other systems, such as, for example, one or more LANs (“Local Area Networks”) and/or one or more WANs (“Wide Area Networks”).

The client device 120 (or the host device 135) is generally capable of executing instructions under the command of a client controller 125 (or a host controller 140). The client device 120 (or the host device 135) is connected to the client controller 125 (or the host controller 140) by a wired or wireless data pathway 130 or 145 capable of delivering data.

The client device 120, the client controller 125, the host device 135, and the host controller 140 each typically includes one or more hardware components and/or software components. An example of a client device 120 or a host device 135 is a general-purpose computer (e.g., a personal computer) capable of responding to and executing instructions in a defined manner. Other examples include a special-purpose computer, a workstation, a server, a device, a component, other physical or virtual equipment or some combination thereof capable of responding to and executing instructions. The client device 120 and the host device 135 may include devices that are capable of peer-to-peer communications.

An example of a client controller 125 or a host controller 140 is a software application loaded on the client device 120 or the host device 135 for commanding and directing communications enabled by the client device 120 or the host device 135. Other examples include a program, a piece of code, an instruction, a device, a computer, a computer system, or a combination thereof, for independently or collectively instructing the client device 120 or the host device 135 to interact and operate as described. The client controller 125 and the host controller 140 may be embodied permanently or temporarily in any type of machine, component, physical or virtual equipment, storage medium, or propagated signal capable of providing instructions to the client device 120 or the host device 135.

The communications link 115 typically includes a delivery network 160 making a direct or indirect communication between the client system 105 and the host system 110, irrespective of physical separation. Examples of a delivery network 160 include the Internet, the World Wide Web, WANs, LANs, analog or digital wired and wireless telephone networks (e.g., PSTN, ISDN, and xDSL), radio, television, cable, satellite, and/or any other delivery mechanism for carrying data. The communications link 115 may include communication pathways 150 and 155 that enable communications through the one or more delivery networks 160 described above. Each of the communication pathways 150 and 155 may include, for example, a wired, wireless, cable or satellite communication pathway.

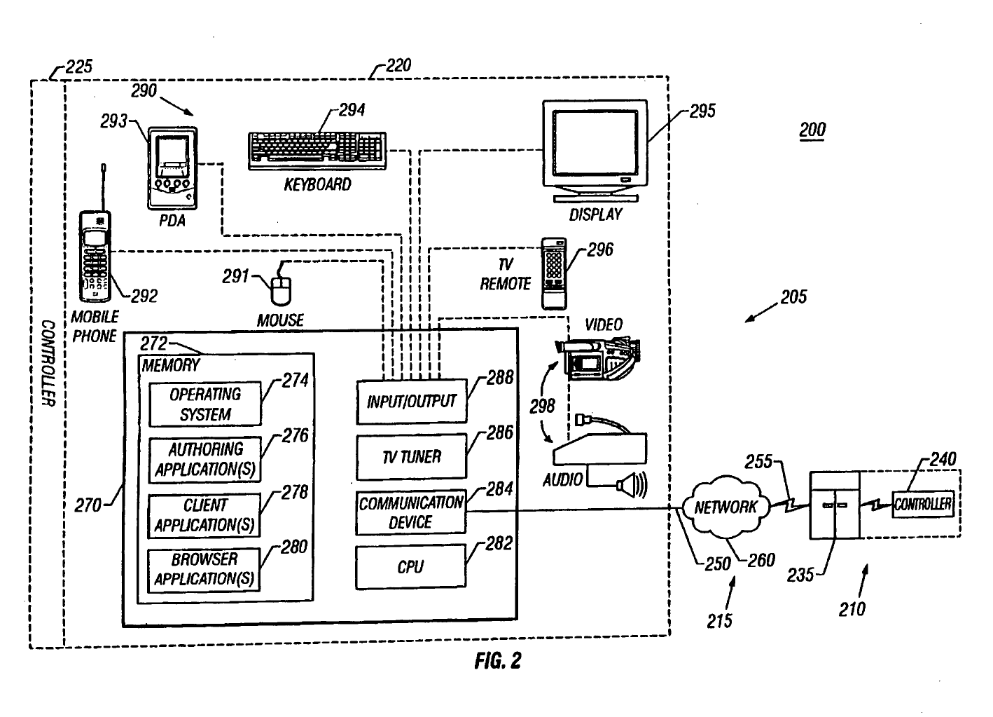

FIG. 2 illustrates a communications system 200 including a client system 205 communicating with a host system 210 through a communications link 215. Client system 205 typically includes one or more client devices 220 and one or more client controllers 225 for controlling the client devices 220. Host system 210 typically includes one or more host devices 235 and one or more host controllers 240 for controlling the host devices 235. The communications link 215 may include communication pathways 250 and 255 that enable communications through the one or more delivery networks 260.

Examples of each element within the communications system of FIG. 2 are broadly described above with respect to FIG. 1. In particular, the host system 210 and communications link 215 typically have attributes comparable to those described with respect to the host system 110 and the communications link 115 of FIG. 1. Likewise, the client system 205 of FIG. 2 typically has attributes comparable to and illustrates one possible implementation of the client system 105 of FIG. 1.

The client device 220 typically includes a general-purpose computer 270 having an internal or external storage 272 for storing data and programs, such as an operating system 274 (e.g., Windows 2000™, Windows Me™, Windows XP™, Windows NT™, OS/2, or Linux) and one or more application programs. Examples of application programs include authoring applications 276 (e.g., word processing programs, database programs, spreadsheet programs, or graphics programs) capable of generating documents or other electronic content; client applications 278 (e.g., AOL client, CompuServe client, AIM client, AOL TV client, or ISP client) capable of communicating with other computer users, accessing various computer resources, and viewing, creating, or otherwise manipulating electronic content; and browser applications 280 (e.g., Netscape's Navigator or Microsoft's Internet Explorer) capable of rendering standard Internet content.

The general-purpose computer 270 also includes a central processing unit 282 (CPU) for executing instructions in response to commands from the client controller 225. In one implementation, the client controller 225 includes one or more of the application programs installed on the internal or external storage 272 of the general-purpose computer 270. In another implementation, the client controller 225 includes application programs externally stored in and performed by one or more device(s) external to the general-purpose computer 270.

The general-purpose computer typically includes a communication device 284 for sending and receiving data. One example of the communication device 284 is a modem. Other examples include a transceiver, a set-top box, a communication card, a satellite dish, an antenna, or another network adapter capable of transmitting and receiving data over the communications link 215 through a wired or wireless data pathway 250. The general-purpose computer 270 also may include a TV tuner 286 for receiving television programming in the form of broadcast, satellite, and/or cable TV signals. As a result, the client device 220 can selectively and/or simultaneously display network content received by communications device 284 and television programming content received by the TV tuner 286.

The general-purpose computer 270 also typically includes an input/output interface 288 for wired or wireless connection to various peripheral devices 290. Examples of peripheral devices 290 include, but are not limited to, a mouse 291, a mobile phone 292, a personal digital assistant 293 (PDA), an MP3 player (not shown), a keyboard 294, a display monitor 295 with or without a touch screen input, a TV remote control 296 for receiving information from and rendering information to users, and an audiovisual input device 298.

Although FIG. 2 illustrates devices such as the mobile telephone 292, the PDA 293 and the TV remote control 296 as being peripheral with respect to the general-purpose computer 270, in another implementation, such devices may themselves include the functionality of the general-purpose computer 270 and operate as the client device 220. For example, the mobile phone 292 or the PDA 293 may include computing and networking capabilities and function as a client device 220 by accessing the delivery network 260 and communicating with the host system 210. Furthermore, the client system 205 may include one, some or all of the components and devices described above.

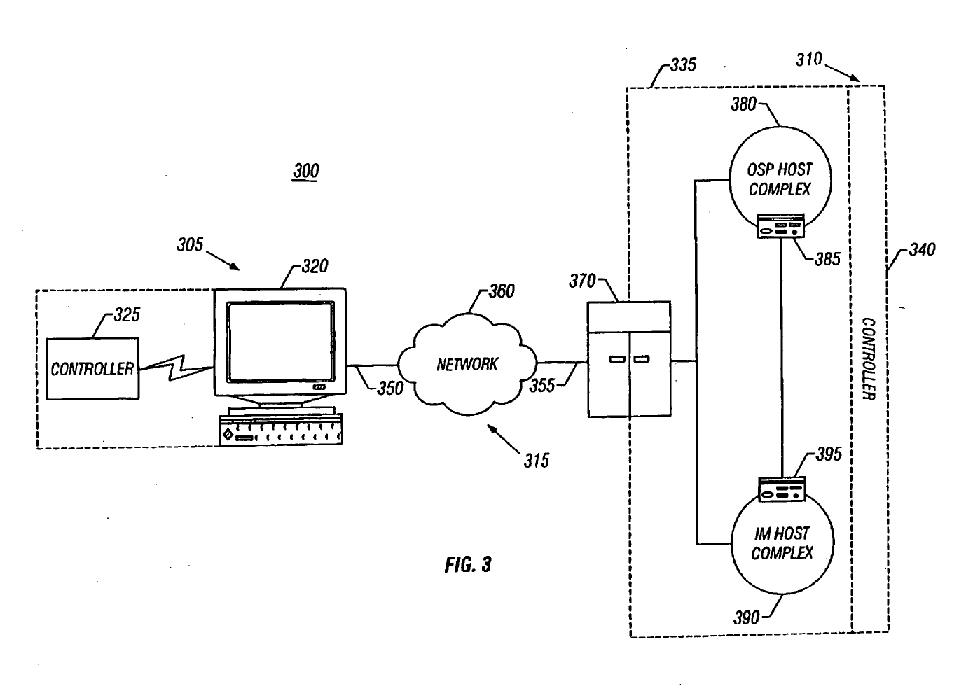

Referring to FIG. 3, a communications system 300 is capable of delivering and exchanging information between a client system 305 and a host system 310 through a communication link 315. Client system 305 typically includes one or more client devices 320 and one or more client controllers 325 for controlling the client devices 320. Host system 310 typically includes one or more host devices 335 and one or more host controllers 340 for controlling the host devices 335. The communications link 315 may include communication pathways 350 and 355 that enable communications through the one or more delivery networks 360.

Examples of each element within the communications system of FIG. 3 are broadly described above with respect to FIGS. 1 and 2. In particular, the client system 305 and the communications link 315 typically have attributes comparable to those described with respect to client systems 105 and 205 and communications links 115 and 215 of FIGS. 1 and 2. Likewise, the host system 310 of FIG. 3 may have attributes comparable to and illustrates one possible implementation of the host systems 110 and 210 shown in FIGS. 1 and 2.

The host system 310 includes a host device 335 and a host controller 340. The host controller 340 is generally capable of transmitting instructions to any or all of the elements of the host device 335. For example, in one implementation, the host controller 340 includes one or more software applications loaded on the host device 335. In other implementations, as described above, the host controller 340 may include any of several other programs, machines, and devices operating independently or collectively to control the host device 335.

The host device 335 includes a login server 370 for enabling access by users and for routing communications between the client system 305 and other elements of the host device 335. The host device 335 also includes various host complexes such as the depicted OSP (“Online Service Provider”) host complex 380 and IM (“Instant Messaging”) host complex 390. To enable access to these host complexes by users, the client system 305 includes communication software, for example, an OSP client application and an IM client application. The OSP and IM communication software applications are designed to facilitate the user's interactions with the respective services and, in particular, may provide access to all the services available within the respective host complexes.

Typically, the OSP host complex 380 supports different services, such as e-mail, discussion groups, chat, news services, and Internet access. The OSP host complex 380 is generally designed with an architecture that enables the machines within the OSP host complex 380 to communicate with each other and employs certain protocols (i.e., standards, formats, conventions, rules, and structures) to transfer data. The OSP host complex 380 ordinarily employs one or more OSP protocols and custom dialing engines to enable access by selected client applications. The OSP host complex 380 may define one or more specific protocols for each service based on a common, underlying proprietary protocol.

The IM host complex 390 is generally independent of the OSP host complex 380, and supports instant messaging services irrespective of a user's network or Internet access. Thus, the IM host complex 390 allows users to send and receive instant messages, whether or not they have access to any particular ISP. The IM host complex 390 may support associated services, such as administrative matters, advertising, directory services, chat, and interest groups related to instant messaging. The IM host complex 390 has an architecture that enables all of the machines within the IM host complex to communicate with each other. To transfer data, the IM host complex 390 employs one or more standard or exclusive IM protocols.

The host device 335 may include one or more gateways that connect and therefore link complexes, such as the OSP host complex gateway 385 and the IM host complex gateway 395. The OSP host complex gateway 385 and the IM host complex gateway 395 may directly or indirectly link the OSP host complex 380 with the IM host complex 390 through a wired or wireless pathway. Ordinarily, when used to facilitate a link between complexes, the OSP host complex gateway 385 and the IM host complex gateway 395 are privy to information regarding the protocol type anticipated by a destination complex, which enables any necessary protocol conversion to be performed incident to the transfer of data from one complex to another. For instance, the OSP host complex 380 and IM host complex 390 generally use different protocols such that transferring data between the complexes requires protocol conversion by or at the request of the OSP host complex gateway 385 and/or the IM host complex gateway 395.

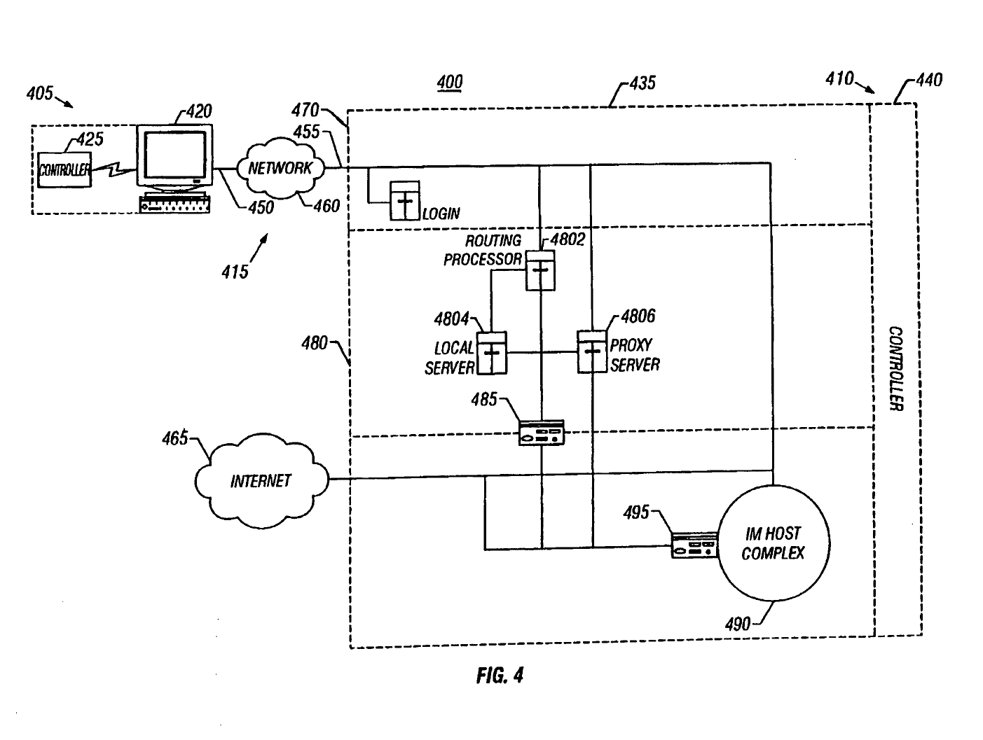

Referring to FIG. 4, a communications system 400 is capable of delivering and exchanging information between a client system 405 and a host system 410 through a communication link 415. Client system 405 typically includes one or more client devices 420 and one or more client controllers 425 for controlling the client devices 420. Host system 410 typically includes one or more host devices 435 and one or more host controllers 440 for controlling the host devices 435. The communications link 415 may include communication pathways 450 and 455 that enable communications through the one or more delivery networks 460. As shown, the client system 405 may access the Internet 465 through the host system 410.

Examples of each element within the communications system of FIG. 4 are broadly described above with respect to FIGS. 1-3. In particular, the client system 405 and the communications link 415 typically have attributes comparable to those described with respect to client systems 105, 205, and 305 and communications links 115, 215, and 315 of FIGS. 1-3. Likewise, the host system 410 of FIG. 4 may have attributes comparable to and illustrates one possible implementation of the host systems 110, 210, and 310 shown in FIGS. 1-3. FIG. 4 describes an aspect of the host system 410, focusing primarily on one particular implementation of OSP host complex 480.

The client system 405 includes a client device 420 and a client controller 425. The client controller 425 is generally capable of establishing a connection to the host system 410, including the OSP host complex 480, the IM host complex 490 and/or the Internet 465. In one implementation, the client controller 425 includes an OSP application for communicating with servers in the OSP host complex 480 using exclusive OSP protocols. The client controller 425 also may include applications, such as an IM client application, and/or an Internet browser application, for communicating with the IM host complex 490 and the Internet 465.

The host system 410 includes a host device 435 and a host controller 440. The host controller 440 is generally capable of transmitting instructions to any or all of the elements of the host device 435. For example, in one implementation, the host controller 440 includes one or more software applications loaded on one or more elements of the host device 435. In other implementations, as described above, the host controller 440 may include any of several other programs, machines, and devices operating independently or collectively to control the host device 435.

The host system 410 includes a login server 470 capable of enabling communications with and authorizing access by client systems 405 to various elements of the host system 410, including an OSP host complex 480 and an IM host complex 490. The login server 470 may implement one or more authorization procedures to enable simultaneous access to the OSP host complex 480 and the IM host complex 490. The OSP host complex 480 and the IM host complex 490 are connected through one or more OSP host complex gateways 485 and one or more IM host complex gateways 495. Each OSP host complex gateway 485 and IM host complex gateway 495 may perform any protocol conversions necessary to enable communications between the OSP host complex 480, the IM host complex 490, and the Internet 465.

The OSP host complex 480 supports a set of services from one or more servers located internal to and external from the OSP host complex 480. Servers external to the OSP host complex 480 generally may be viewed as existing on the Internet 465. Servers internal to the OSP complex 480 may be arranged in a variety of configurations. For example, servers may be arranged in centralized or localized clusters in order to distribute servers and users within the OSP host complex 480.

In one implementation of FIG. 4, the OSP host complex 480 includes a routing processor 4802. In general, the routing processor 4802 will examine an address field of a data request, use a mapping table to determine the appropriate destination for the data request, and direct the data request to the appropriate destination. In a packet-based implementation, the client system 405 may generate information requests, convert the requests into data packets, sequence the data packets, perform error checking and other packet-switching techniques, and transmit the data packets to the routing processor 4802. Upon receiving data packets from the client system 405, the routing processor 4802 may directly or indirectly route the data packets to a specified destination within or outside of the OSP host complex 480. For example, in the event that a data request from the client system 405 can be satisfied locally, the routing processor 4802 may direct the data request to a local server 4804. In the event that the data request cannot be satisfied locally, the routing processor 4802 may direct the data request externally to the Internet 465 or the IM host complex 490 through the gateway 485.

The OSP host complex 480 also includes a proxy server 4806 for directing data requests and/or otherwise facilitating communication between the client system 405 and the Internet 465. The proxy server 4806 may include an IP (“Internet Protocol”) tunnel for converting data from OSP protocol into standard Internet protocol and transmitting the data to the Internet 465. The IP tunnel also converts data received from the Internet 465 in the standard Internet protocol back into the OSP protocol and sends the converted data to the routing processor 4802 for delivery back to the client system 405.

The proxy server 4806 also may allow the client system 405 to use standard Internet protocols and formatting to access the OSP host complex 480 and the Internet 465. For example, the user may use an OSP TV client application having an embedded browser application installed on the client system 405 to generate a request in standard Internet protocol, such as HTTP (“HyperText Transport Protocol”). In a packet-based implementation, data packets may be encapsulated inside a standard Internet tunneling protocol, such as, for example, UDP (“User Datagram Protocol”) and routed to the proxy server 4806. The proxy server 4806 may include an L2TP (“Layer Two Tunneling Protocol”) tunnel capable of establishing a point-to-point protocol (PPP) session with the client system 405.

The proxy server 4806 also may act as a buffer between the client system 405 and the Internet 465, and may implement content filtering and time saving techniques. For example, the proxy server 4806 can check parental controls settings of the client system 405 and request and transmit content from the Internet 465 according to the parental control settings. In addition, the proxy server 4806 may include one or more caches for storing frequently accessed information. If requested data is determined to be stored in the caches, the proxy server 4806 may send the information to the client system 405 from the caches and avoid the need to access the Internet 465.

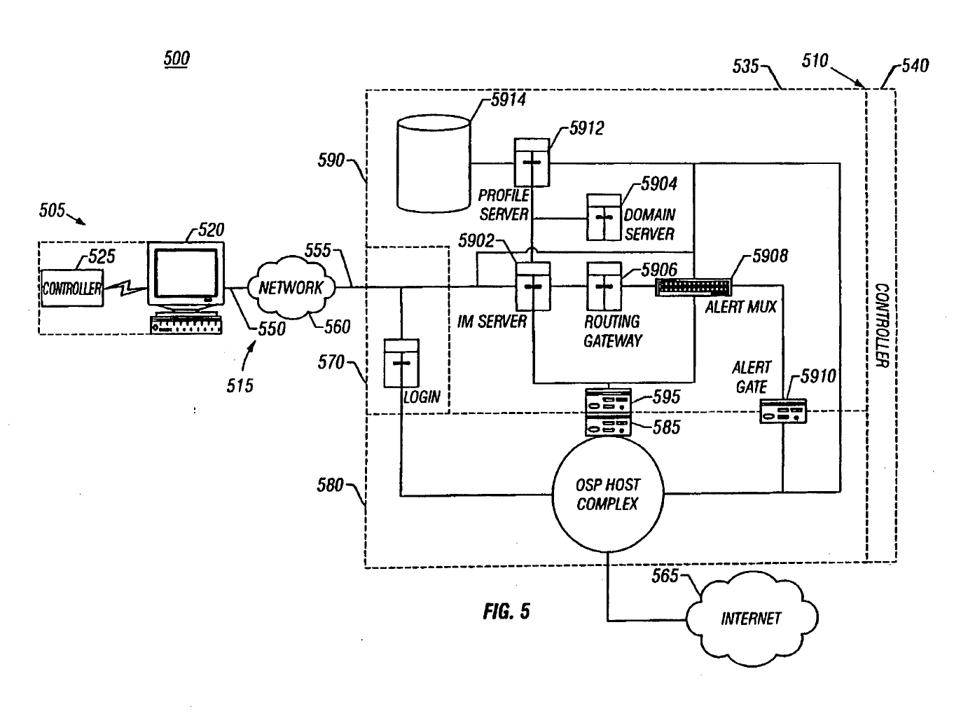

Referring to FIG. 5, a communications system 500 is capable of delivering and exchanging information between a client system 505 and a host system 510 through a communication link 515. Client system 505 typically includes one or more client devices 520 and one or more client controllers 525 for controlling the client devices 520. Host system 510 typically includes one or more host devices 535 and one or more host controllers 540 for controlling the host devices 535. The communications link 515 may include communication pathways 550 and 555 that enable communications through the one or more delivery networks 560. As shown, the client system 505 may access the Internet 565 through the host system 510.

Examples of each element within the communications system of FIG. 5 are broadly described above with respect to FIGS. 1-4. In particular, the client system 505 and the communications link 515 typically have attributes comparable to those described with respect to client systems 105, 205, 305, and 405 and communications links 115, 215, 315, and 415 of FIGS. 1-4. Likewise, the host system 510 of FIG. 5 may have attributes comparable to and illustrates one possible implementation of the host systems 110, 210, 310, and 410 shown in FIGS. 1-4. FIG. 5 describes an aspect of the host system 510, focusing primarily on one particular implementation of IM host complex 590.

The client system 505 includes a client device 520 and a client controller 525. The client controller 525 is generally capable of establishing a connection to the host system 510, including the OSP host complex 580, the IM host complex 590 and/or the Internet 565. In one implementation, the client controller 525 includes an IM application for communicating with servers in the IM host complex 590 using exclusive IM protocols. The client controller 525 also may include applications, such as an OSP client application, and/or an Internet browser application for communicating with the OSP host complex 580 and the Internet 565, respectively.

The host system 510 includes a host device 535 and a host controller 540. The host controller 540 is generally capable of transmitting instructions to any or all of the elements of the host device 535. For example, in one implementation, the host controller 540 includes one or more software applications loaded on one or more elements of the host device 535. However, in other implementations, as described above, the host controller 540 may include any of several other programs, machines, and devices operating independently or collectively to control the host device 535.

The host system 510 includes a login server 570 capable of enabling communications with and authorizing access by client systems 505 to various elements of the host system 510, including an OSP host complex 580 and an IM host complex 590. The login server 570 may implement one or more authorization procedures to enable simultaneous access to the OSP host complex 580 and the IM host complex 590. The OSP host complex 580 and the IM host complex 590 are connected through one or more OSP host complex gateways 585 and one or more IM host complex gateways 595. Each OSP host complex gateway 585 and IM host complex gateway 595 may perform any protocol conversions necessary to enable communication between the OSP host complex 580, the IM host complex 590, and the Internet 565.

To access the IM host complex 590 and begin an IM session, the client system 505 establishes a connection to the login server 570. The login server 570 typically determines whether the particular user is authorized to access the IM host complex 590 by verifying a user identification and password. If the user is authorized to access the IM host complex 590, the login server 570 employs a hashing technique on the user's screen name to identify a particular IM server 5902 for use during the user's session. The login server 570 provides the client system 505 with the IP address of the particular IM server 5902, gives the client system 505 an encrypted key (i.e., a cookie), and breaks the connection. The client system 505 then uses the IP address to establish a connection to the particular IM server 5902 through the communications link 515, and obtains access to that IM server 5902 using the encrypted key. Typically, the client system 505 will be equipped with a Winsock API (“Application Programming Interface”) that enables the client system 505 to establish an open TCP connection to the IM server 5902.

Once a connection to the IM server 5902 has been established, the client system 505 may directly or indirectly transmit data to and access content from the IM server 5902 and one or more associated domain servers 5904. The IM server 5902 supports the fundamental instant messaging services and the domain servers 5904 may support associated services, such as, for example, administrative matters, directory services, chat and interest groups. In general, the purpose of the domain servers 5904 is to lighten the load placed on the IM server 5902 by assuming responsibility for some of the services within the IM host complex 590. By accessing the IM server 5902 and/or the domain server 5904, a user can use the IM client application to view whether particular users (“buddies”) are online, exchange instant messages with particular users, participate in group chat rooms, trade files such as pictures, invitations or documents, find other users with similar interests, get customized news and stock quotes, and search the World Wide Web.

In the implementation of FIG. 5, the IM server 5902 is directly or indirectly connected to a routing gateway 5906. The routing gateway 5906 facilitates the connection between the IM server 5902 and one or more alert multiplexors 5908, for example, by serving as a link minimization tool or hub to connect several IM servers 5902 to several alert multiplexors 5908. In general, an alert multiplexor 5908 maintains a record of alerts and users registered to receive the alerts.

Once the client system 505 is connected to the alert multiplexor 5908, a user can register for and/or receive one or more types of alerts. The connection pathway between the client system 505 and the alert multiplexor 5908 is determined by employing another hashing technique at the IM server 5902 to identify the particular alert multiplexor 5908 to be used for the user's session. Once the particular multiplexor 5908 has been identified, the IM server 5902 provides the client system 505 with the IP address of the particular alert multiplexor 5908 and gives the client system 505 an encrypted key (i.e., a cookie). The client system 505 then uses the IP address to connect to the particular alert multiplexor 5908 through the communication link 515 and obtains access to the alert multiplexor 5908 using the encrypted key.

The alert multiplexor 5908 is connected to an alert gate 5910 that, like the IM host complex gateway 595, is capable of performing the necessary protocol conversions to form a bridge to the OSP host complex 580. The alert gate 5910 is the interface between the IM host complex 590 and the physical servers, such as servers in the OSP host complex 580, where state changes are occurring. In general, the information regarding state changes will be gathered and used by the IM host complex 590. However, the alert multiplexor 5908 also may communicate with the OSP host complex 580 through the IM host complex gateway 595, for example, to provide the servers and users of the OSP host complex 580 with certain information gathered from the alert gate 5910.

The alert gate 5910 can detect an alert feed corresponding to a particular type of alert. The alert gate 5910 may include a piece of code (alert receive code) capable of interacting with another piece of code (alert broadcast code) on the physical server where a state change occurs. In general, the alert receive code installed on the alert gate 5910 instructs the alert broadcast code installed on the physical server to send an alert feed to the alert gate 5910 upon the occurrence of a particular state change. Upon detecting an alert feed, the alert gate 5910 contacts the alert multiplexor 5908, which, in turn, informs the client system 505 of the detected alert feed.

In the implementation of FIG. 5, the IM host complex 590 also includes a user profile server 5912 connected to a database 5914 for storing large amounts of user profile data. The user profile server 5912 may be used to enter, retrieve, edit, manipulate, or otherwise process user profile data. In one implementation, a user's profile data includes, for example, the user's buddy list, alert preferences, designated stocks, identified interests, and geographic location. The user may enter, edit and/or delete profile data using an installed IM client application on the client system 505 to interact with the user profile server 5912.

Because the user's data is stored in the IM host complex 590, the user does not have to reenter or update such information in the event that the user accesses the IM host complex 590 using a new or a different client system 505. Accordingly, when a user accesses the IM host complex 590, the IM server 5902 can instruct the user profile server 5912 to retrieve the user's profile data from the database 5914 and to provide, for example, the user's buddy list to the IM server 5902 and the user's alert preferences to the alert multiplexor 5908. The user profile server 5912 also may communicate with other servers in the OSP host complex 580 to share user profile data with other services. Alternatively, user profile data may be saved locally on the client device 505.

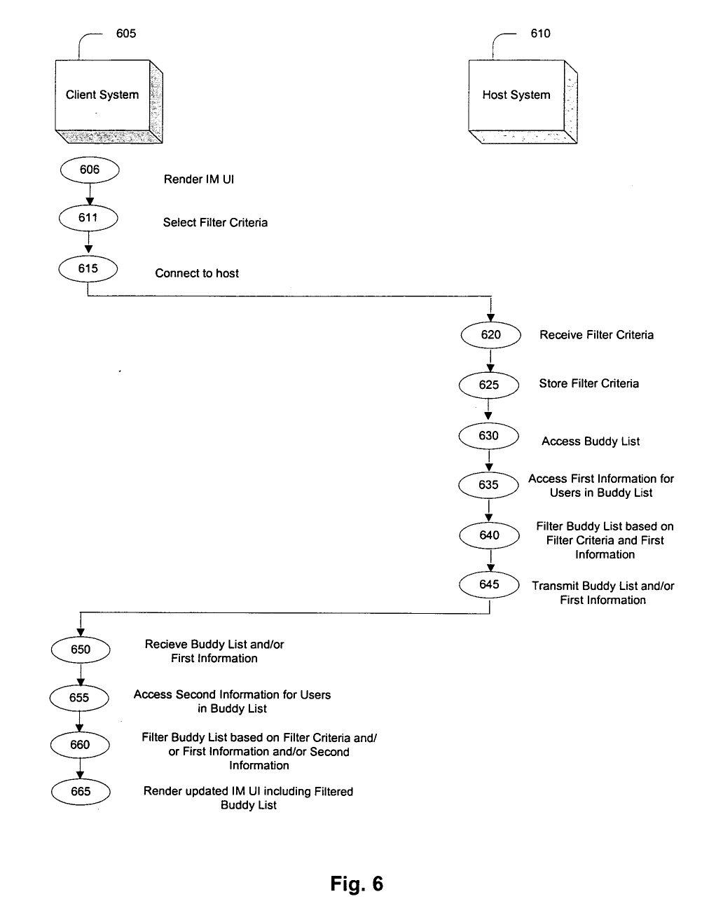

Referring to FIG. 6, a client system 605 and a host system 610 exchange communications according to a procedure 600. The procedure 600 may be implemented by various types of hardware (e.g., a device, a computer, a computer system, equipment or a component); software (e.g., a program, an application, instructions or code); storage media (e.g., a disk, an external memory, an internal memory or a propagated signal); or combinations thereof.

Examples of each element of FIG. 6 are broadly described with respect to FIGS. 1-5 above. In particular, the client system 605 may have attributes comparable to those described with respect to client systems 105, 205, 305, 405 and 505, client devices 120, 220, 320, 420 and 520, and/or client controllers 125, 225, 325, 425, and 525. The host system 610 may have attributes comparable to those described with respect to host systems 110, 210, 310, 410 and 510, host devices 135, 235, 335, 435 and 535, and/or host controllers 140, 240, 340, 440 and 540. The client system 605 and/or the host system 610 may be directly or indirectly interconnected through a known or described delivery network, such as delivery networks 160, 260, 360, 460 and 560.

In one implementation, the client system 605 is associated with a user (e.g., a first instant messaging participant) and includes an application for accessing the host system 610. A user's transfer preferences may be maintained locally at the application or remotely at the host system 610. Each user may use the application to set individual preferences for allowing messages and/or files to be transferred to and from other users. Typically, a graphical user interface (“UI”) is displayed to allow each user to select among various levels of security and/or to grant (or deny) access to others users.

More specifically, the client system 605 is a user and/or a client (e.g., client system 505), and the host system 610 includes one or more host complexes (e.g., OSP host complex 580 and/or IM host complex 590) for providing instant messaging capability and coordinating the transfer of electronic data between users. The client system 605 may access the host system 610 using various available devices and/or controllers.

An example of a device is a general-purpose computer capable of responding to and executing instructions in a defined manner. Other examples include a special-purpose computer, a personal computer (“PC”), a workstation, a server, a laptop, a Web-enabled telephone, a Web-enabled personal digital assistant (“PDA”), an interactive television set, a set top box, a video tape recorder (“VTR”), a DVD player, an on-board (i.e., vehicle-mounted) computer, or any other component, machine, tool, equipment, or some combination thereof capable of responding to and executing instructions.

An example of a controller is a software application (e.g., an operating system, a browser application, a microbrowser application, a server application, a proxy application, a gateway application, a tunneling application, an e-mail application, an IM client, an online service provider client application, an interactive television client application, and/or an ISP client) loaded on a device to command and direct communications enabled by the device. Other examples include a computer program, a piece of code, an instruction, another device, or some combination thereof, for independently or collectively instructing the device to interact and operate as desired. The controller may be embodied permanently or temporarily in any type of machine, component, physical or virtual equipment, storage medium, or propagated signal capable of providing instructions to a device. In particular, the controller (e.g., a software application or a computer program) may be stored on a storage media or device (e.g., a ROM, a magnetic diskette, or a propagated signal) readable by a general or special purpose programmable computer, such that if the storage media or device is read by a computer system, the functions described herein are performed.

To communicate using instant messaging, the client system 605 accesses the host system 610. In order to access the host system 610, the client system 605 requests authentication or recognition by the host system 610. The request identifies the associated user to the host system 610 for subsequent identification to other users using a unique screen name. The client system 605 may include a Winsock API for opening and establishing a TCP connection to the host system 610.

The host system 610 verifies a user's information (e.g., screen name and password) against data stored in a user database. If the user's information is verified, the host system 610 authorizes access and or acknowledges the user. If the user's information is not verified, the host system 610 denies access and sends an error message.

After being authorized, a direct (i.e., socket) connection may be established through the host system 610 to allow the client system 605 to communicate. The client system 605 uses this connection to communicate with the host system 610 and with other users. This connection remains available during the time that the client system 605 is accessing the host system 610, or until either party to an IM communications session decides to terminate.

Upon accessing the host system 610, a “buddy list” (i.e., a list of other instant messaging participants or “buddies” that are identified by the user) is displayed to the user. In general, a user's buddy list is maintained with or accessible as part of a user's user profile and may be made accessible using a user interface (UI) that provides the online status and capabilities of screen names associated with the user's buddies. In particular, the host system 610 informs the client system 605 whether identified buddies are online (i.e., currently accessing the host system 610). The host system 610 also informs any user who has identified the client system 605 as a buddy that the client system 605 is currently online.

A buddy list may be used to facilitate IM communications between users. For example, a user can activate an IM user interface that is pre-addressed to a buddy simply by selecting the screen name of an online buddy from the buddy list.

Alternatively, by way of example, if a recipient is not a “buddy,” the user generally initiates IM communications by activating a blank IM user interface and then addressing that interface to the screen name of the intended recipient. When necessary, a user may be able to look up the screen name of an intended recipient using the intended recipient's e-mail address.

In the implementation of FIG. 6, a client system 605 and a host system 610 interact according to a procedure 600 that extends the functionality of instant messaging by filtering the buddy list displayed to the user of the client system 605.

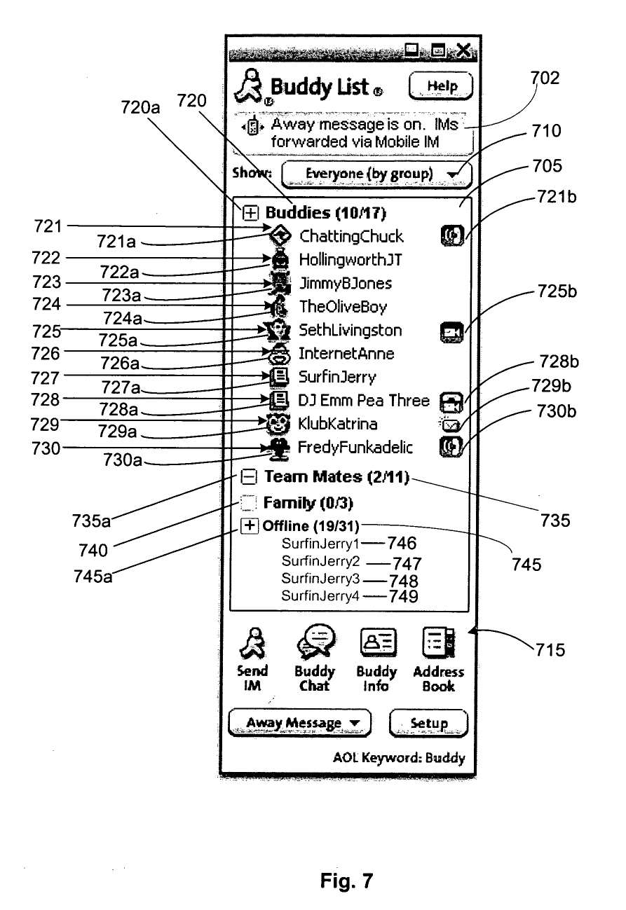

Initially, the client system 605 renders an IM UI (step 606). The IM UI includes a buddy list. Examples of an IM UI are shown in FIGS. 7-14.

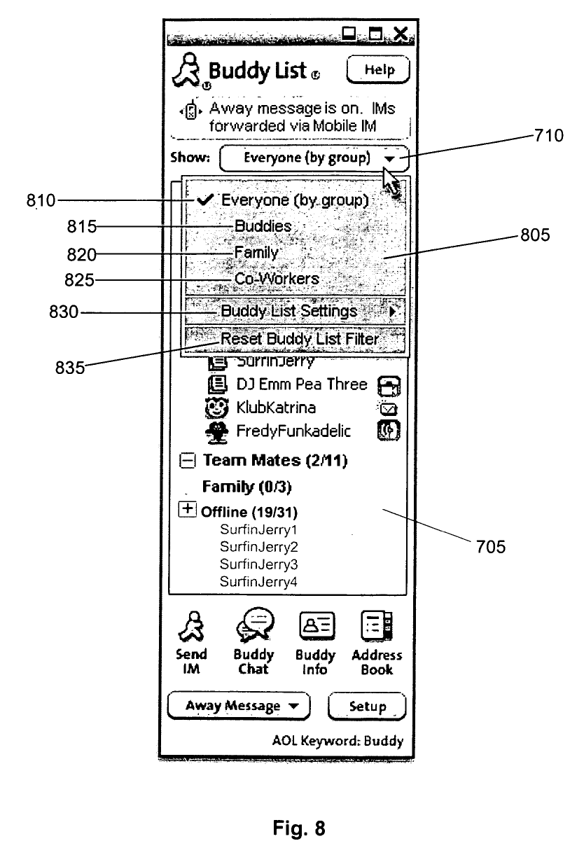

Next, the user selects filter criteria at the client system 605 (step 611). The user may select filter criteria through a user interface, such as the UI shown in FIGS. 8, 9, and 11. The filter criteria may be selected manually and/or automatically, and may include default values that may be modified by a user. The filter criteria enables the user buddy list display to be filtered, for example, by criteria such as online presence state (e.g., online, offline, away, idle or mobile), alphabetical order, group, or user ranked priority (e.g., a high, medium, or low priority).

Next, the client system 605 connects to the host system 610 (step 615). The client system 605 and the host system 610 are physically and/or logically connected. For example, the client system 605 may connect to the host system 610 across the network (e.g., network 160) by supplying a user ID and password to a server (e.g., a login server) in order to obtain access to the host system 610.

The host system 610 then receives the filter criteria from the client system 605 (step 620). The host system 610 also may optionally store the filter criteria (step 625). In other implementations, the filter criteria may additionally or alternatively be stored locally at the client system 605 or remotely at a remote server other than the host system 610.

The host system 610 accesses the user's buddy list (step 630). Typically, the buddy list is stored at the host system 610. The host system 610 then accesses first information for the buddies that are members of the accessed buddy list (step 635). The first information may include information such as the online presence status of a buddy, the group to which the buddy is assigned, and a priority assigned to a particular buddy based on an automatic ranking, a user ranking, or a default ranking. The priority or ranking may be assigned by, for example, the user, the client system, or the host system.

Optionally, the host system 610 may filter the buddy list based on the selected filter criteria and the accessed first information (step 640). This results in a filtered buddy list that later may be transmitted to the client system 605. In another implementation, the filtering of the buddy list takes place at the client system 605 rather than the host system 610.

The host system 610 transmits the buddy list and/or first information to the client system 605 (step 645). The transmitted buddy list may be an unfiltered buddy list, when the optional filtering is not performed, or a filtered buddy list, when the optional filtering is performed. The client system 605 receives the buddy list and/or the first filtered information from the host system 610 (step 650).

Next, the client system 605 optionally may access second information for one or more of the buddies that are members of the received buddy list (step 655). Second information may be stored locally at the client system 605, or may be accessed by the client system 605 from a different source such as a remote server. Typically, second information is information that is not available to the host system 610. For example, second information may be information contained in a local address book, a local calendar, or a recently received instant message at the client system 605, or a client system assigned or user-assigned ranking stored locally at the client system 605.

Next, the client system 605 filters the buddy list based on the selected filter criteria, the accessed first information, and/or the accessed second information (step 660). This results in a filtered buddy list in which the buddy list members are displayed according to the selected filter criteria.

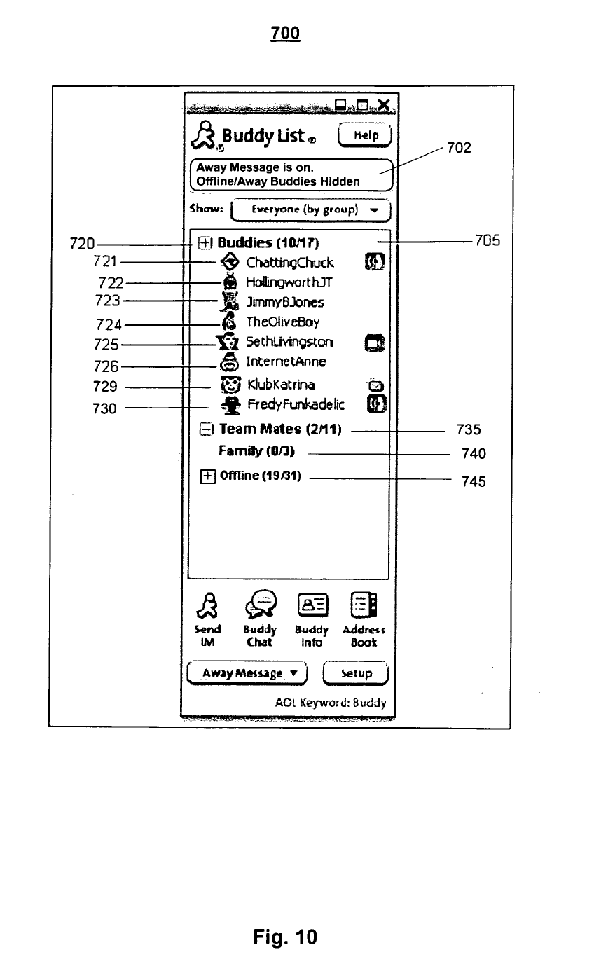

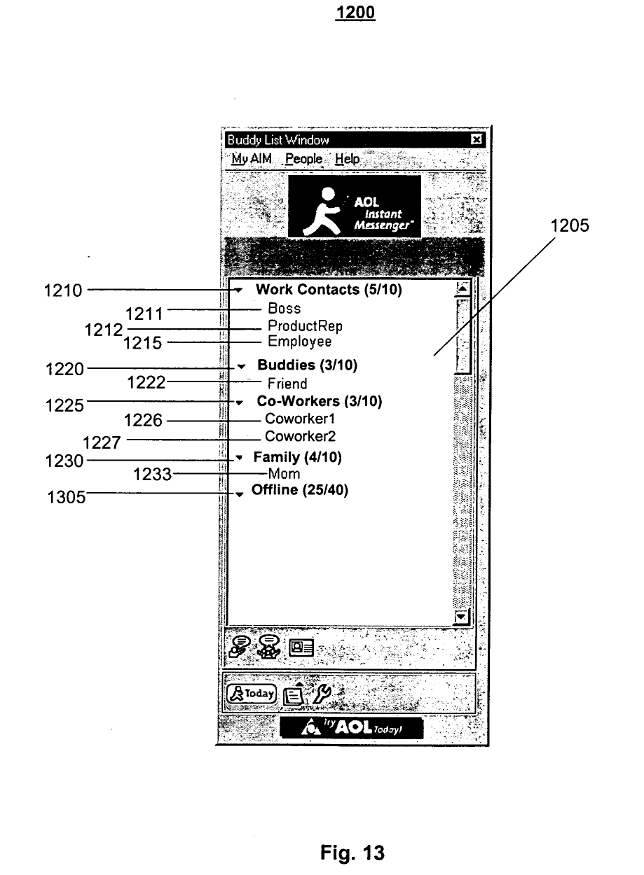

The client system 605 renders an updated IM UI that includes the final filtered buddy list (step 660). Examples of an updated IM user interface are shown by FIGS. 10 and 13, which are discussed below.

FIG. 7 illustrates one example of an IM user interface 700, which in this case is a buddy list user interface that displays a list of other users (“buddies”) with whom the user wishes to communicate. The buddies who are members of the buddy list typically are selected by the user for inclusion on the buddy list. The buddies on the buddy list may be grouped into one of several groups or categories, which may include one or more default groups, one or more automatically defined groups (e.g., recently added buddies), and/or one or more user defined groups. As shown, UI 700 includes a buddy list window 705. The buddy list window 705 includes a display of the buddies on the buddy list and is organized according to user-selected, automatically-selected, default, or other criteria.

The UI 700 also includes a filter control 710 that provides a way for the user to filter and sort the buddy list. The filter control 710 also allows the user to see what filter criteria are active in the filtering of the buddy list. The UI 700 further includes a status display 702 that enables the user to view the status of other instant messaging options. The UI 700 also includes a set of controls 715 that allow the user to, for example, send an instant message, initiate a chat session, get information about a designated buddy, or access the address book. The controls 715 also includes controls for an away message and setup of the buddy list.

The buddy list window 705 includes groups of buddies, such as groups 720, 735, 740, and 745. Individual buddies are assigned to a group by the user or by default. As shown, the “Buddies” group 720 includes a total of 17 buddies, 10 of whom are currently online (buddies 721-730) and displayed under the “Buddies” group heading 720. Each buddy has an associated buddy icon or status indicator 721a-730a. As shown, status indicators 727a and 728a indicate that buddies 727 and 728 respectively have an away status. The buddy list window 705 also includes capability information about various buddies, such as capability icons 721b, 725b, 728b, 729b, and 730b. As shown, the capability icons indicate an ability to conduct voice instant messaging (721b and 730b), to conduct video messaging (capability icon 728b), to conduct voice and video messaging (capability icon 729b), and to support voice mail (capability icon 729b).

The group “TeamMates” 735 has a total of 11 members, two of whom are online. Adjacent to the TeamMates group 735 and to the Buddies group 720 are minimizing icons 735a and 720a, respectively, which can be toggled between a “plus” sign wherein the associated group is maximized and a “minus” sign wherein the associated group is minimized. As shown, Buddies Group 720 is maximized so that all of the online buddies in that group are displayed. In contrast, the TeamMates group 735 is minimized so that the online buddies are hidden from view. The online buddies in the TeamMates group 735 can be viewed by toggling minimizing icon 735a.

The “Family” group 740 has a total of three members, none of whom are online. There is no minimizing icon adjacent to the Family group 740 because none of the buddies in that group are online. The “Offline” group 745 has a total of 31 members, 19 of who are currently online, and four of whom (746, 747, 748, and 749) are currently displayed in the available display space in the buddy list window 705. Adjacent to the Offline group 745 is a minimizing icon 745a that allows the user to hide the online buddies in that group.

The filter control 710 displays the name of the filter currently being applied to the buddy list (“Everyone (by group)”). When the mouse pointer hovers over the filter control 710, the full name of the filter may be displayed in a tool tip if it is too long to be displayed in the available space for the filter control 710.

FIG. 8 illustrates another view of instant messaging UI 700, showing a filter control drop down menu 805 that is displayed over a portion of buddy list window 705. Menu 805 is activated when a user manipulates the filter control 710 by, for example, using the mouse pointer 807 to click on the filter control 710 or having the mouse pointer 807 hover over the filter control 710 for a pre-determined amount of time. The filter control drop down menu 805 includes filter options that enable the user to display everyone in the buddy list by group (option 810), display only the “Buddies” group in the buddy list (option 815), display only the “Family” group in the buddy list (option 820), display only the “Co-Workers” group in the buddy list (option 825), display buddy list settings (option 830), and reset the buddy list filter to the default settings (option 835). Other menu controls in the filter control drop down menu 805 may be provided. The menu 805 typically is displayed by default, but advanced settings also may be included to control the options in the menu. For example, a “more options” menu item (not shown) may be displayed. When filtering by a specific group, such as “Buddies,” “Families,” or “Co-Workers,” the groups available for filtering of the buddy list that are displayed in the drop down menu 805 will correspond to the groups defined in the user's buddy list, and may differ from the groups that are shown in the example of FIG. 8. Typically, when the drop down menu 805 is closed, the buddy list 705 (shown in FIG. 7) is updated with the appropriate filter applied.

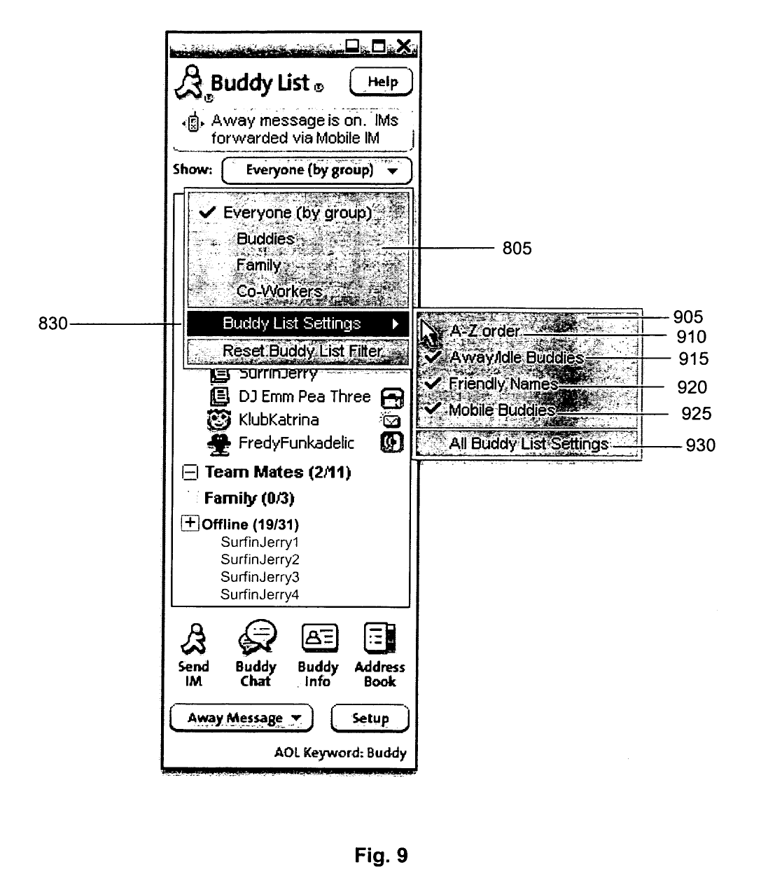

FIG. 9 illustrates another view of IM UI 700 showing a filter control fly out menu 830. If a user manipulates the filter control menu item 830 on the filter control drop down menu 805, then the filter control fly-out menu 905 is rendered to the user. The filter control fly-out menu 905 includes options that affect the display of the buddy list. As shown, the fly-out menu 905 includes the following options, each of which can be turned on (indicated by a check mark) or off (indicated by no check mark): an alphabetical order option 910 that causes the buddies on the buddy list to be placed in an alphabetical order rather than in an order of entry or a group-based order; an away/idle buddies option 915 that enables the display or hiding of buddies who have an idle or away state; a friendly name option 920 that replaces the screen name in the buddy list with a buddy nickname or a first and last name of the buddy; and, a mobile buddy option 925 that enables the display or hiding of buddies who are using mobile devices. In addition, fly out menu 905 includes an all buddy list settings option 930 that invokes a further buddy list setting menu item with other filtering options.

FIG. 10 illustrates another example of IM UI 700 in which the users having an online presence state of away or idle have been filtered from the buddy list 705. Thus, the buddy list window 705 shows the groups 720, 735, 740, and 745 and also shows buddies 721-726, 729 and 730 described with respect to FIG. 7. Buddies 727 and 728 of FIG. 7 have been filtered from the display in the buddy list 705 because they have an away state, as indicated by the away status icons 727a and 728a that were shown in UI 700 of FIG. 7. Further, offline buddies 746 through 749 are no longer displayed because offline buddies have been filtered from the display in the example shown in FIG. 10. The status display 712 indicates that the offline/away buddies have been filtered by displaying “Offline/Away Buddies Hidden.”

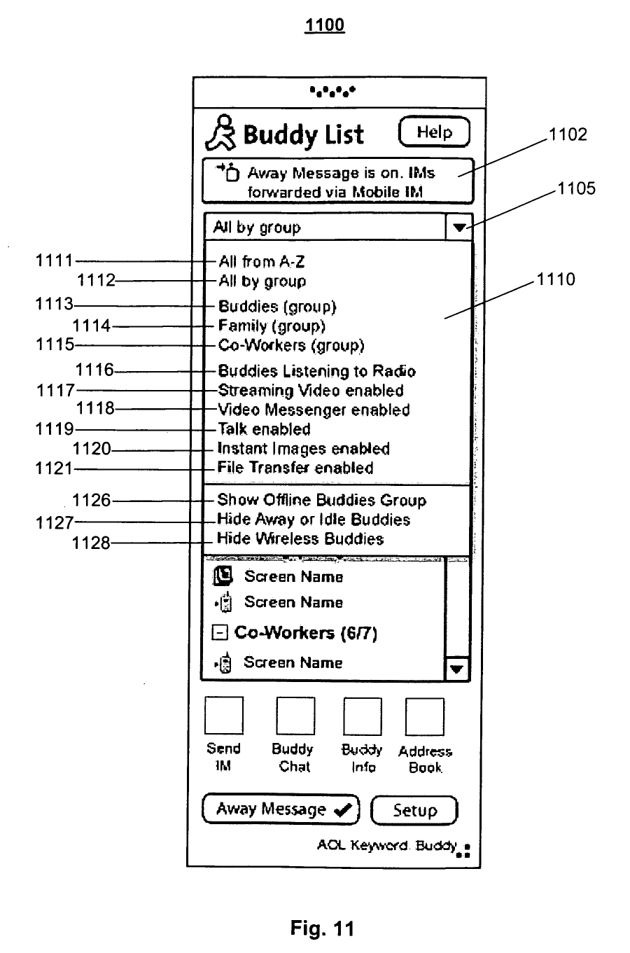

FIG. 11 illustrates another example of an IM UI 1100 that enables a user to select one or more filter criteria for a buddy list. The UI 1100 includes a status display 1102 that enables a user to determine the status of buddy list filtering and the status of other instant messaging options. The UI 1100 also includes a filter drop down control 1105 that, when manipulated by the user, renders a filter drop down menu 1110. The filter drop down menu 1110 includes menu items 1111-1128. Menu item 1111 enables the user to filter the buddies in the buddy list alphabetically. Menu item 1112 allows a user to filter the buddies in the buddy list by using a user-assigned group or a default group. Menu items 1113, 1114, and 1115 enable the display of buddies within a particular group, which, as shown, are the “Buddies” group from menu item 1113, the “Family” group from menu item 1114, and the “Co-Workers” group from menu item 1115. Menu item 1116 enables the buddy list to be filtered according to buddies listening to a radio. Menu item 1117 enables the buddy list to be filtered according to buddies who have streaming video enabled. Menu item 1118 enables the buddy list to be filtered according to whether the buddies have a video messenger enabled. Menu item 1119 enables the buddy list to be filtered according to whether a buddy has a talk feature enabled. Menu item 1120 enables the buddy list to be filtered according to whether the buddy has instant images enabled, and menu item 1121 enables the buddy list to be filtered according to whether the buddy has file transfer enabled. Menu item 1126 enables the user to show or hide the offline buddies group. Menu item 1127 enables the user to hide away or idle buddies. Menu item 1128 enables the user to hide wireless or mobile buddies. Many other display controls and menu items are possible to filter the display of the buddy list. The capabilities of buddies corresponding to the menu items 1116-1121 may be indicated by buddy list capability icons, such as icons 721b, 725b, 728b, 729b, and 730b described above with respect to FIG. 7.

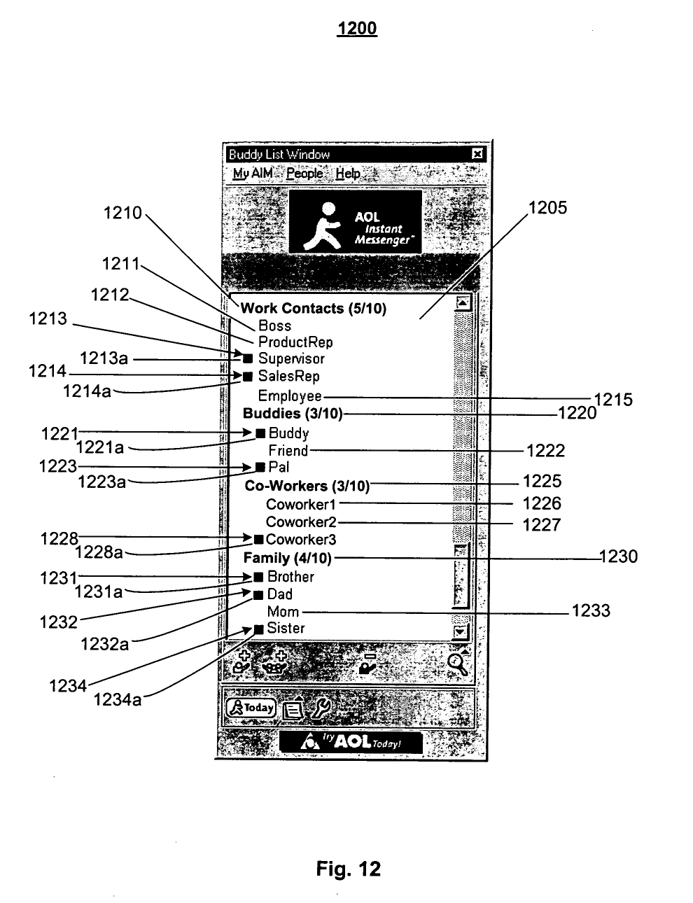

FIG. 12 illustrates another example of a buddy list UI 1200 prior to a buddy list filtering operation. UI 1200 includes a buddy list window 1205 that is organized with user defined groups and particular buddies assigned by the user to each group. As shown, the buddy list window 1205 includes a “Work Contacts” group 1210 to which buddies 1211-1215 are assigned. Online presence state indictors 1213a and 1214a are associated with buddies 1213 and 1214, respectively. In one implementation, the indicators 1213a and 1214a may indicate that the corresponding buddies 1213 and 1214 are away, idle, or otherwise unavailable for an instant messaging conversation. The online presence state indicator may include an appearance or font characteristic of the buddy's screen name. For example, an idle state may be indicated by changing the font of the buddy's screen name to a gray shading or other coloring. Absence of an online presence state indicator for buddies listed in a particular group may indicate that the buddy is online and available for an IM conversation.

Buddy list window 1205 also includes a “Buddies” group 1220 that includes buddies 1221-1223. Online presence state indicators 1221a and 1223a are associated with buddies 1221 and 1223, respectively. The buddies list window 1205 also includes a “Co-Workers” group 1225 that includes buddies 1226-1228. An online presence state indicator 1228a is associated with buddy 1228. Also shown is a “Family” group 1230 that includes buddies 1231-1234. Online presence state indicators 1231a, 1232a, and 1234a are associated with buddies 1231, 1232, and 1234, respectively. In the example of FIG. 12, an online presence state indicator is only rendered for buddies who are not available to engage in an instant messaging communications session.

FIG. 13 illustrates another view of buddy list UI 1200 showing the display to the user after buddy list filtering has been performed. As shown, the buddy list filtering has been performed on the buddies having an online presence state indicator (thus, indicating unavailability to engage in an IM conversation). Thus, the buddies Supervisor 1213, Sales Rep 1214, Buddy 1221, Pal 1223, CoWorker3 1228, Brother 1231, Dad 1232, and Sister 1234 that were shown as having online status indicators in FIG. 12 are not shown in FIG. 13. FIG. 13 also shows an offline buddies group 1305, in which no members are displayed because all are unavailable to engage in an IM conversation.

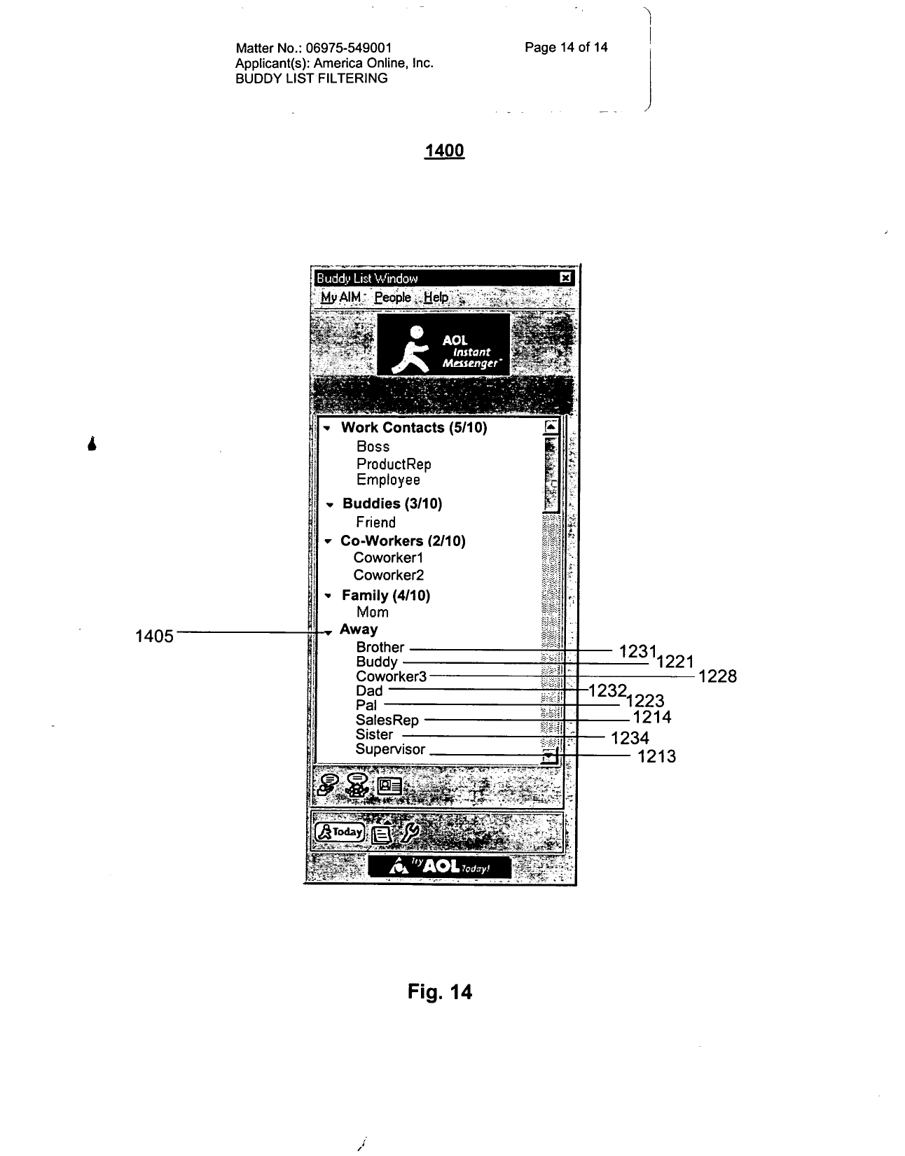

FIG. 14 illustrates a further example of an instant messaging user interface 1400 that is similar to the UI 1200 of FIGS. 12 and 13. In the example of FIG. 14, an “Away” group 1405 automatically filters and displays those particular buddies having a designated online presence state. The “Away” group 1405 shows the buddies Supervisor 1213, Sales Rep 1214, Buddy 1221, Pal 1223, CoWorker3 1228, Brother 1231, Dad 1232, and Sister 1234 that were shown as having online status indicators in FIG. 12. As the buddies shown under the “Away” buddies group 1405 change their online presence state to indicate availability to engage in an instant messaging conversation, the buddy list UI 1400 is updated to reflect this change in online presence state and the buddy is moved out of the “Away” group and displayed in the appropriate group based on their new online presence state or other group affiliation.

A number of implementations have been described. Nevertheless, it will be understood that various modifications may be made. These and other implementations are within the scope of the following claims.

1. A method of customizing instant messaging communications for a first instant messaging participant, the method comprising:
receiving first filter criteria corresponding to an online presence state of instant messaging participants to be filtered;
accessing first information associated with each of one or more other instant messaging participants selected by the first instant messaging participant;
applying the first filter criteria to the first information for each of the other instant messaging participants to obtain a first filter result for each of the other instant messaging participants; and
configuring a participant list to persistently reflect a display of information about the other instant messaging participants according to the first filter result for each of the other instant messaging participants.

2-52. (canceled)

53. A method of customizing a list of users for a first user, the method comprising:
receiving from the first user first filter criteria corresponding to an online presence state of users to be filtered;
accessing first information associated with each of one or more other users selected by the first user;
applying the first filter criteria to the first information for each of the other users to obtain at least one first filter result; and
configuring a user list to persistently reflect a display of information about the other users according to the at least one first filter result.

54. The method of claim 53 wherein configuring the user list comprises including or excluding at least one of the other users in the display of the user list based on the at least one first filter result.

55. The method of claim 53 wherein configuring the user list comprises sorting the other users in the display of the user list based on the at least one first filter result.

56. The method of claim 53 wherein configuring the user list comprises grouping the other users in the display of the user list based on the at least one first filter result.

57. The method of claim 53 wherein the first information comprises an online presence state information for each of the other users.

58. The method of claim 53 wherein the at least one first filter result comprises an online presence state for each of the other users.

59. The method of claim 53 wherein applying the first filter criteria comprises applying the first filter criteria at a host system that communicates with a client system at which the user list is displayed.

60. The method of claim 53 wherein applying the first filter criteria comprises applying the first filter criteria at a client system at which the user list is displayed.

61. The method of claim 53 further comprising
receiving second filter criteria;
accessing second information associated with each of one or more other users; and
applying the second filter criteria to the second information for each of the other users to obtain at least one second filter result;
wherein configuring the user list comprises configuring the user list to persistently reflect a display of information about the other users according to the at least one first and at least one second filter results.

62. The method of claim 61 wherein configuring the user list comprises including or excluding each of the other users in the display of the user list based on the at least one first filter result and sorting the other users in the display of the user list based on the at least one second filter result.

63. The method of claim 61 wherein configuring the user list comprises including or excluding each of the other users in the display of the user list based on the at least one first filter result and grouping the other users in the display of the user list based on the at least one second filter result.

64. The method of claim 61 wherein configuring the user list comprises sorting the other users in the display of the user list based on the at least one first filter result and grouping the other users in the display of the user list based on the at least one second filter result.

65. The method of claim 61 wherein the second filter criteria is based upon an alphabetical order of users.

66. The method of claim 61 wherein the second filter criteria is based upon a priority associated with users.

67. The method of claim 66 wherein the priority comprises a priority assigned by the first user.

68. The method of claim 66 wherein the priority comprises an automatically assigned priority.

69. The method of claim 66 wherein the priority comprises a default priority.

70. The method of claim 61 wherein the second information comprises group assignment information.

71. The method of claim 61 wherein the second information comprises assigned priority information.

72. The method of claim 71 wherein the priority comprises a priority assigned by the first user.

73. The method of claim 71 wherein the priority comprises an automatically assigned priority.

74. The method of claim 61 wherein the second filter result comprises an instant messaging group.

75. The method of claim 53 further comprising displaying the filtered user list to the first user.

76. The method of claim 53 wherein configuring the user list comprises configuring a displayed order of screen names of the one or more other users.

77. The method of claim 76 wherein configuring the user list comprises changing the displayed order of the screen names.

78. The method of claim 76 wherein configuring the user list comprises configuring the user list to display the other users according to a priority associated with each of the other users.

79. The method of claim 53 wherein the first user and the one or more other users comprise instant messaging participants.

80. A computer program stored on a computer readable medium, the computer program comprising instructions for:
receiving from a first user first filter criteria corresponding to an online presence state of users to be filtered;
accessing first information associated with each of one or more other users selected by the first user;
applying the first filter criteria to the first information for each of the other users to obtain at least one first filter result; and
configuring a user list to persistently reflect a display of information about the other users according to the at least one first filter result.

81. The computer program of claim 80 wherein the first user and the one or more other users comprise instant messaging participants.

82. The computer program of claim 80 wherein the instructions for configuring the user list comprise instructions for including or excluding at least one of the other users in the display of the user list based on the at least one first filter result.

83. The computer program of claim 80 wherein the instructions for configuring the user list comprise instructions for sorting the other users in the display of the user list based on the at least one first filter result.

84. The computer program of claim 80 wherein the instructions for configuring the user list comprise instructions for grouping the other users in the display of the user list based on the at least one first filter result.

85. The computer program of claim 80 wherein the first information comprises an online presence state information for each of the other users.

86. The computer program of claim 80 wherein the first filter result comprises an online presence state for each of the other users.

87. The computer program of claim 80 wherein the instructions for applying the first filter criteria comprise instructions for applying the first filter criteria at a host system that communicates with a client system at which the user list is displayed.

88. The computer program of claim 80 wherein the instructions for applying the first filter criteria comprise instructions for applying the first filter criteria at a client system at which the user list is displayed.

89. The computer program of claim 80 further comprising instructions for:
receiving second filter criteria;
accessing second information associated with each of one or more other users; and
applying the second filter criteria to the second information for each of the other users to obtain at least one second filter result;
wherein the instructions for configuring the user list comprise instructions for configuring the user list to persistently reflect a display of information about the other users according to the at least one first and at least one second filter results.

90. The computer program of claim 89 wherein the instructions for configuring the user list comprise instructions for including or excluding each of the other users in the display of the user list based on the at least one first filter result and sorting the other users in the display of the user list based on the at least one second filter result.

91. The computer program of claim 89 wherein the instructions for configuring the user list comprise instructions for including or excluding each of the other users in the display of the user list based on the at least one first filter result and grouping the other users in the display of the user list based on the at least one second filter result.

92. The computer program of claim 89 wherein the instructions for configuring the user list comprise instructions for sorting the other users in the display of the user list based on the at least one first filter result and grouping the other users in the display of the user list based on the at least one second filter result.

93. The computer program of claim 89 wherein the second filter criteria is based upon an alphabetical order of users.

94. The computer program of claim 89 wherein the second filter criteria is based upon a priority associated with users.

95. The computer program of claim 94 wherein the priority comprises a priority assigned by the first user.

96. The computer program of claim 94 wherein the priority comprises an automatically assigned priority.

97. The computer program of claim 94 wherein the priority comprises a default priority.

98. The computer program of claim 89 wherein the second information comprises group assignment information.

99. The computer program of claim 89 wherein the second information comprises assigned priority information.

100. The computer program of claim 99 wherein the priority comprises a priority assigned by the first user.

101. The computer program of claim 99 wherein the priority comprises an automatically assigned priority.

102. The computer program of claim 89 wherein the second filter result comprises an instant messaging group.

103. The computer program of claim 80 further comprising instructions for displaying the filtered user list to the first user.

104. The computer program of claim 80 wherein the instructions for configuring the user list comprise instructions for configuring a displayed order of screen names of the one or more other users.

105. The computer program of claim 104 wherein the instructions for configuring the user list comprise instructions for changing the displayed order of the screen names.

106. The computer program of claim 104 wherein the instructions for configuring the user list comprise instructions for configuring the user list to display the other users according to a priority associated with each of the other users.

107. The computer program of claim 80 wherein the first user and the one or more other users comprise instant messaging participants.
